(19) United States
(12) Patent Application Publication
(10) Pub. No.: US 2008/0278771 A1
(43) Pub. Date: Nov. 13, 2008

(54) IMAGE READING APPARATUS

(76) Inventor: Hiroyuki FUTAMI, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/044,651

(22) Filed: Mar. 7, 2008

(30) Foreign Application Priority Data
May 9, 2007 (JP) 2007-124781

(51) Int. Cl. H04N 1/40

(52) U.S. Cl. 358/461; 358/474; 358/449

(57) ABSTRACT

Disclosed in an image reading apparatus including a reading unit to obtain an image data by irradiating a document with a light and reading an image of the document, a paper thickness detection unit to detect a thickness of the document to be read by the reading unit, a process unit to process the image data which is obtained by the reading unit based on a parameter and a control unit to carry out a control of changing the parameter of the process unit according to the thickness of the document which is detected by the paper thickness detection unit.

### BACKGROUND OF THE INVENTION

1. Field of the Invention

The present invention relates to a technique to improve an image reading quality in an image reading apparatus comprising a reading unit which carries out the reading in a condition where the distance to the surface opposite to the reading surface of the document is constant.

2. Description of Related Art

As for an image reading apparatus and an image forming apparatus which carry out reading of a document, there is known an apparatus which carries out the reading of one surface of the document by comprising one reading device, an apparatus which carries out the reading of both surfaces of the document by comprising one reading device and by making the document reciprocate (switch back) and an apparatus which carries out the reading (simultaneously reading both surfaces) both surfaces while conveying the document by comprising two reading devices.

Particularly, there is known an image reading apparatus which concurrently carries out the reading of both surfaces by using two reading devices in one time passing of paper (one pass) while conveying the document in one direction. Such image reading apparatus has a good productivity because reading of both surfaces of the document can be carried out in short time, and there are advantages such that damage to the document is small, that complicated reversing mechanism is not needed, and the like.

JP8-265576A discloses the relating techniques and suggestions regarding the above simultaneous reading of both surfaces.

Further, JP2004-320472A (page 1, FIG. 1) and JP2003-65752A (page 1, FIG. 1) disclose the above type of image reading apparatuses in which the amount of light at the time of reading is changed according to the thickness of the document.

The image reading apparatus disclosed in JP8-265576A (page 1, FIG. 1) comprises a platen glass as one of the reading device and a document is mounted on the platen glass. Alternatively, it is structured so that the document which moves on the platen glass is irradiated with a light, and the document is read by a reading device such as the CCD or the like.

Further, it is structured so that a reading device such as the contact image sensor (CIS) or the like which carries out the reading in a condition where the distance to the surface opposite to the reading surface of the document is constant, that is, in a condition where the distance to the reading surface changes by the thickness of the document is disposed in the middle of the conveyance path of the document and carries out the reading as the other reading device.

In this case, in the other reading device, a document guide plate and a white standard plate are disposed at a position where the back surface of the reading surface of the document contacts, and the document guide plate and the white standard plate functions as a guide when the document passes.

Therefore, when the document in which the thickness is thicker than usual is to be read, the reading surface approximates the reading device and the reflection of the light which illuminated the document becomes stronger than usual.

That is, it becomes in a condition where the brightness is changed comparing to the original image data. In such case, when the document becomes thick, the distance to the reading surface changes by the thickness of the document. Further, a phenomenon called a white smear may occur due to the saturation of the signal because an image data which is brighter than usual is obtained.

Moreover, on the opposite surface of the document to be read on the platen glass, the distance to the reading device does not change by the thickness of the document, and the original image data is obtained. As a result, when both surfaces are being read, it is not preferable because the reading is carried out in a condition where the brightness of the image data is different between the front surface and the back surface of the document.

In JP2004-320472A (page 1, FIG. 1) and JP2003-65752A (page 1, FIG. 1), there is described a control of the amount of light at the time of reading in order to inhibit the back printing which occurs according to the paper thickness. However, it is difficult to adjust the amount of light because of the performance and the like of the lamp in such technique of controlling the amount of light, and minor correction is difficult to be carried out although an adjustment just about to prevent the back printing is possible. Therefore, the minor changes of the reading density which is caused by the varying of the distance from the reading device to the reading surface of the document by the thickness of the document cannot be corrected in such technique. Particularly, the minor change in the reading density becomes a problem in which the density of the images in the front surface and the back surface are different when both surfaces are being read.

### SUMMARY OF THE INVENTION

In order to solve the above problems, a main object of the present invention is to provide an image forming apparatus which can attempt to improve the quality of the read image even when the distance from the reading unit to the document reading surface changes due to the thickness of the document.

In order to achieve the above object, according to the first aspect of the present invention, an image reading apparatus comprises a reading unit to obtain an image data by irradiating a document with a light and reading an image of the document, a paper thickness detection unit to detect a thickness of the document to be read by the reading unit, a process unit to process the image data which is obtained by the reading unit based on a parameter and a control unit to carry out a control of changing the parameter of the process unit according to the thickness of the document which is detected by the paper thickness detection unit.

Further, according to the second aspect of the present invention, an image reading apparatus comprises a reading unit to obtain an image data by irradiating a document with a light and reading an image of the document, an input unit in which information relating to a thickness of the document to be read by the reading unit is input, a process unit to process the image data which is obtained by the reading unit based on a parameter and a control unit to carry out a control of changing the parameter of the process unit according to information relating to the thickness of the document which is input from the input unit.

Moreover, according the third aspect of the present invention, an image reading apparatus comprises a first reading unit to read one surface of a document, a second reading unit to obtain an image data by irradiating the other surface of the document with a light and reading the other surface of the document while the one surface of the document is read by the first reading unit, a paper thickness detection unit to detect a thickness of the document to be read by the reading unit, a process unit to process the image data based on a parameter and a control unit to detect the thickness of the document from a signal obtained by the first reading unit and to carry out a control of changing the parameter which is used when the image data read by the second reading unit is processed according to the detected thickness of the document in the process unit.

### BRIEF DESCRIPTION OF THE DRAWINGS

The present invention will become more fully understood from the detailed description given hereinbelow and the appended drawings, and thus are not intended as a definition of the limits of the present invention, and wherein:

FIG. 1 is a functional block diagram showing an electrical structure of the image reading apparatus according to the embodiment of the present invention;

FIG. 2 is a configuration diagram showing a mechanical structure of the image reading apparatus according to the embodiment of the present invention;

FIG. 3A is a configuration diagram showing a structure of the image reading apparatus according to the embodiment of the present invention;

FIG. 3B is a configuration diagram showing a structure of the image reading apparatus according to the embodiment of the present invention;

FIG. 3C is a configuration diagram showing a structure of the image reading apparatus according to the embodiment of the present invention;

FIG. 4 is a flowchart showing a process operation according to the embodiment of the present invention;

FIG. 5A is an explanatory diagram showing an aspect of paper thickness detection according to the present invention;

FIG. 5B is an explanatory diagram showing an aspect of the paper thickness detection according to the present invention;

FIG. 6 is an explanatory diagram showing an aspect of paper thickness detection according to the present invention;

FIG. 7 is an explanatory diagram showing an operation of the image reading apparatus according to the embodiment of the present invention;

FIG. 8 is an explanatory diagram showing an operation of the image reading apparatus according to the embodiment of the present invention;

FIG. 9A is an explanatory diagram showing an operation of the image reading apparatus according to the embodiment of the present invention;

FIG. 9B is an explanatory diagram showing an operation of the image reading apparatus according to the embodiment of the present invention; and

FIG. 10 is an explanatory diagram showing an operation of the image reading apparatus according to the embodiment of the present invention.

### DESCRIPTION OF THE PREFERRED EMBODIMENTS

Hereinafter, the best mode (hereinafter, embodiment) to carry out the present invention will be described in detail with reference to the drawings.

The embodiment of the present invention can be applied to an image reading apparatus (scanner) which reads the content of a document as image information and which generates and outputs the image data or can be applied to an image forming apparatus (copying apparatus) which comprises a function of reading the content of an object targeted for copying (document) by a document reading unit (scanner) as image information and a function of copying the object. Further, the embodiment of the present invention can be applied to an image transmission apparatus (facsimile apparatus) which comprises a function of reading the content of an object targeted for transmission (document) by a document reading unit (scanner) as image information and a function of transmitting the information via a communication line.

### <Mechanical Structure of the Image Reading Apparatus>

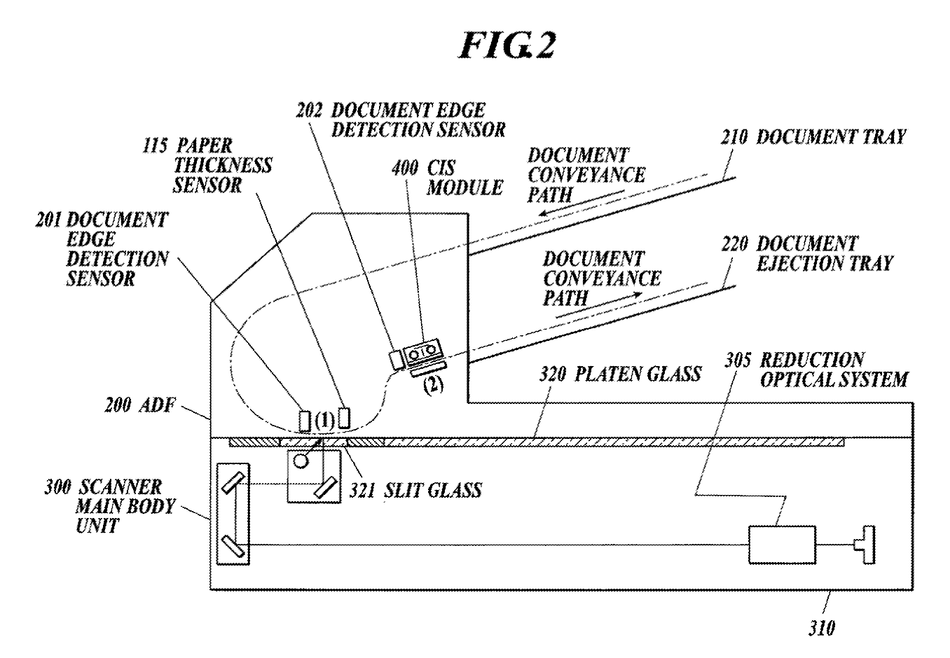

First, a mechanical structure of the image reading apparatus according to the embodiment will be described with reference to FIG. 2. Here, an image reading apparatus having a function of simultaneously or concurrently reading both sides of a document in one conveyance which is called one pass without using the reversing function while automatically conveying the document is used as a specific example of the embodiment.

Here, details regarding a roller used for conveying the document and driving the conveyance, a motor to drive the roller, a motor driving circuit, a gear and the like are omitted, and the conveyance and the reading of the document are principally shown as a diagram.

The ADF 200 reads an image on the front surface of the document by the CCD 310 as the first reading unit via the reduction optical system 305 of the scanner main body unit 300 at the position (1) (the position where the slit glass 321 is passed through) while the ADF 200 conveys the document which is mounted on the document tray 210 in the arrow direction shown in the drawing. Thereafter, the ADF 200 reads the image on the back surface of the document at the CIS (Contact Image Sensor) module 400 which is the adhesive type second reading unit at the position (2) and ejects the document in the document ejection tray 220.

The document edge detection sensor 201 is disposed right before the reading position of the first reading unit, and the document edge detection sensor 202 is disposed right before the reading position of the second reading unit.

Moreover, the document mounted on the platen glass 320 can be read by the scanner main body unit 300 without using the ADF 200.

That is, by concurrently reading the front surface and the back surface of the document by different reading units, respectively, in one time passing of the document (one pass), damage to the document is reduced by not using the complicated reversing function and the productivity is attempted to be improved.

In the embodiment shown in FIG. 2, the CCD 310 as the first reading unit reads the reduced image of the document via the reduction optical system such as a mirror, a lens or the like. On the other hand, the CIS module 400 as the second reading unit reads the image of the document which is in the same magnification. The first reading unit and the second reading unit both may be the adhesive type CIS module.

### <Electrical Structure of the Image Reading Apparatus>

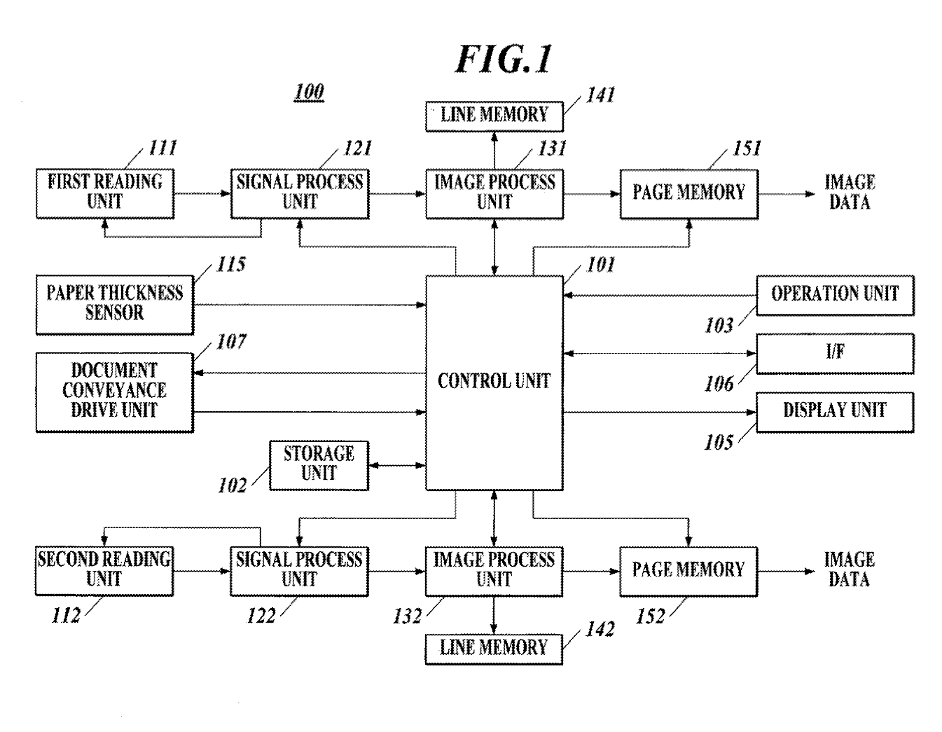

FIG. 1 is a block diagram showing the detail structure of inside of the image reading apparatus 100 according to the first embodiment of the present invention. FIG. 1 mainly shows the periphery of the part necessary for the operational description of the features of the embodiment, and other parts which are known as the image reading apparatus are omitted from the drawing.

Reference numeral 101 denotes a control unit as a control device to control each part of the image reading apparatus 100. The control unit 101 reads the document and executes various types of control relating to variable process.

Here, the control unit 101 constitutes the control device which carries out the control of changing the parameter of the image process in the second reading unit side according to the thickness of the detected document. Further, the control unit 101 constitutes the control device which carries out the control of changing the parameter of the image process in the second reading unit side according to the thickness of the input document. The control unit 101 also constitutes the control device which carries out the control of changing the parameter of the image process in the second reading unit side according to the thickness of the document which is detected from the reading result in the first reading unit side.

Reference numeral 102 denotes a storage unit to store various types of data and various types of parameters, and stores various types of parameters which are mentioned below as needed.

Reference numeral 103 denotes an operation unit in which various types of instructions such as specifying of the document size, starting of the reading and the like from a user are input. The operation unit 103 also constitutes the input device in which information relating to the thickness of the document to be read is input.

Reference numeral 105 denotes a display unit of the image reading apparatus 100, and displays various types of conditions and various types of messages by letters, numerical codes, pictorial symbols and the like based on the control of the control unit 101. Alternatively, the display unit 105 displays and announces the conditions and the messages by an audio and a blinking of light as needed. The operation unit 103 and the display unit 105 may be integrally constituted in a touch panel form.

Reference numeral 106 denotes an interface to carry out communication with an external device via a network or a communication line. The interface 106 also constitutes the input device in which information relating to the thickness of the document to be read is input.

Reference numeral 107 denotes a document conveyance driving unit which carries out the conveyance drive of the document based on an instruction of the control unit 101. As a part of the document conveyance driving unit 107, the document edge detection sensor 201 and the document edge detection sensor 202 are provided, and the detection results are informed to the control unit 101.

Reference numeral 111 denotes the first reading unit which constitutes the first reading device, and is a reduction type reading device which carries out the reading of the image on the first surface (front surface) of the document by the CCD via the reduction optical system in the specific example shown in FIG. 2.

Reference numeral 121 denotes a signal process unit which applies various types of driving signals needed for the first reading unit 111 and which carries out a predetermined signal process to the read signal obtained from the first reading unit 111 to convert the read signal into the digitalized image data.

Reference numeral 131 denotes an image process unit which carries out the shading correction, the detection of the document width (size in the main-scanning direction), the tone correction and the like to the image data which is obtained by being read at the first reading unit 111, by using the line memory 141. Reference numeral 151 denotes a page memory which stores the image data by page unit.

Reference numeral 112 denotes the second reading unit which constitutes the second reading device, and is the second reading device which carries out the reading of the image on the second surface (back surface) of the document by the adhesive type CIS module 400 in the specific example shown in FIG. 2.

Reference numeral 115 denotes a contact type or a non-contact type paper thickness sensor which detects the thickness of the document. When the paper thickness is detected by referring to the read result which is obtained by the reading carried out by the first reading unit 111 as described below, there is no need to provide the paper thickness sensor 115.

Reference numeral 122 denotes a signal process unit which applies various types of driving signal which are needed for the second reading unit 112 and which carries out a predetermined signal process to the read signal which is obtained from the second reading unit 112 to convert the read signal into the digitalized image data.

Reference numeral 132 denotes an image process unit which carries out the shading correction, the detection of the document width (size of the main-scanning direction), the tone correction and the like to the image data which is obtained by being read at the second reading unit 112 by using the line memory 142. Reference numeral 152 denotes a page memory which stores the image data by page unit.

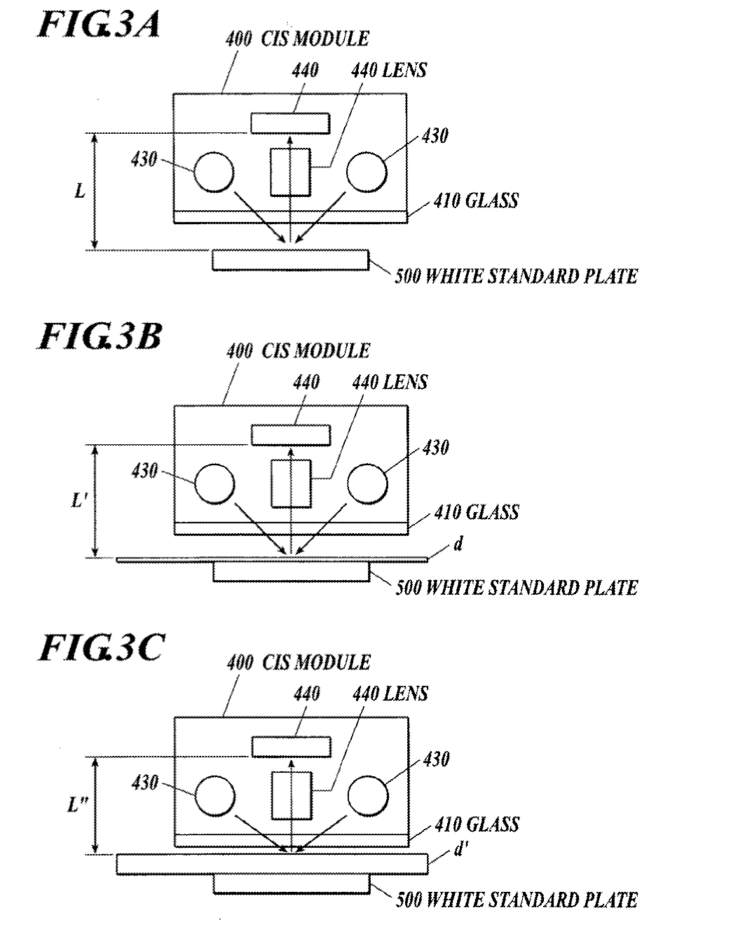

FIGS. 3A to 3C are explanatory diagrams showing a configuration of the CIS module 400. The CIS module 400 is constituted so as to carry out the reading of the document by setting the direction which is orthogonal to the paper surface as the longitudinal direction.

As shown in FIG. 3A, the CIS module 400 comprises the glass 410 in the reading surface side and comprises two lamps 430 inside thereof as an illuminating device. The lens allay 440 is provided in the middle of the two lamps 430. The sensor modules 440 as a photoelectric conversion device is disposed at one end side of the lens allay 440.

The white standard plate 500 is disposed at the reading position which is L distance away from the sensor module 440. The reading result of the white standard plate 500 is used as the white standard at the time of the shading correction, and further the white standard plate 500 is used as a guide plate at the time of reading the document.

As shown in FIG. 3B, the reading is carried out in a condition where the distance from the sensor module 440 to the back surface of the reading surface of the document d is constant when the document d having a general thickness is being read. That is, the reading position is at the position L′ distance=L−(thickness of document d) away from the sensor module 440.

Moreover, as shown in FIG. 3C, the reading is carried out in a condition where the distance from the sensor module 440 to the back surface of the reading surface of the document d′ is constant when the document d′ in which the thickness is thicker than the document d having a general thickness is being read. That is, the reading position is at the position L″ distance=L−(thickness of document d′) away from the sensor module 440.

### <Operation Condition of the First Embodiment>

Hereinafter, an operation of the image reading apparatus according to the first embodiment will be described in detail by referring to the flowchart in FIG. 3.

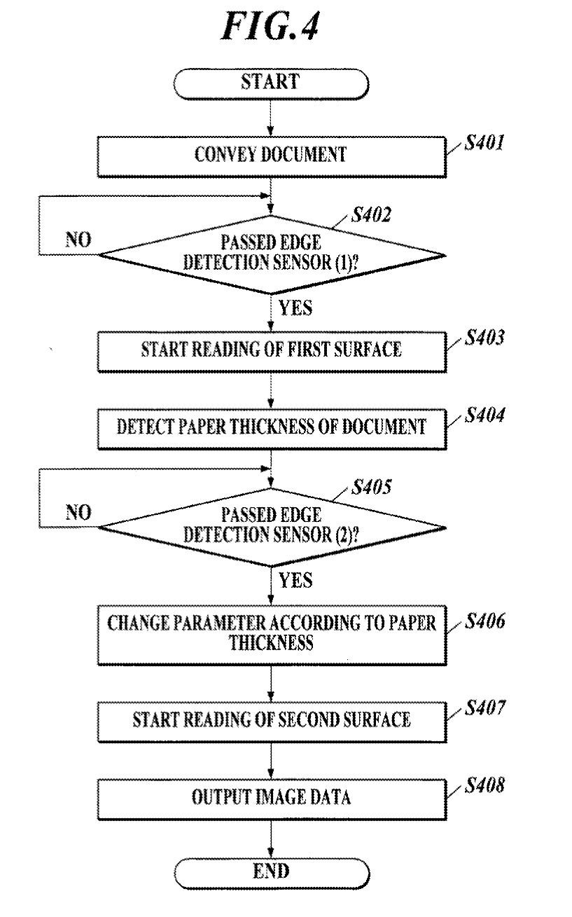

First, the overall process of the embodiment will be described by FIG. 4. When it is instructed to start reading both sides from the operation unit 103 of the image reading apparatus 100 or when it is instructed to start reading both sides from an outside computer or the like which is not shown in the drawing, the control unit 101 executes the process shown in the flowchart of FIG. 4.

First, the control unit 101 gives the instruction to convey the document to the document conveyance drive unit 107. The document conveyance drive unit 107 which received this instruction conveys the document mounted on the document tray 210 one by one so as the document passes through the path shown in dashed line in FIG. 2 (step S401 in FIG. 4).

When it is detected that the edge of the conveyed document have passed the document edge detection sensor 201 (YES in step S402 in FIG. 4), the reading region valid signal (V-VALIT, H-VALID) is supplied to the first reading unit 111 from the signal process unit 121 which received an instruction from the control unit 101, and the reading of the first surface of the document is started (step S403 in FIG. 4). Supply of the reading region valid signal (V-VALID, H-VALID) from the signal process unit 121 which received an instruction from the control unit 101 is continued and the reading of the first surface of the document is continued until it is detected that the back edge of the document have passed the document edge detection sensor 201.

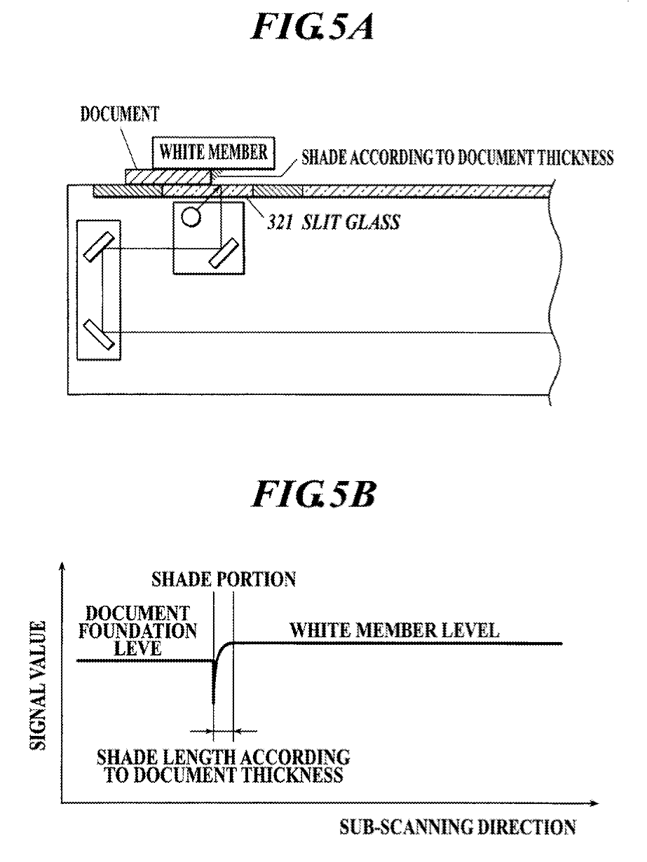

From the detection result of the paper thickness sensor 115 or from the reading result of the first surface of the document, thickness of the document is detected (step S404 in FIG. 4). Here, when the paper thickness sensor 115 is being used, various types of sensors which are commercially available as a contact type or a non-contact type sensor may be used. Further, when the paper thickness is detected from the reading result of the first surface of the document, the control unit 101 can presume the paper thickness from the length of the shade of the document in the sub-scanning direction, which is generated by the illumination for reading as shown in FIG. 5A. In such case, the paper thickness can be presumed easily because the paper thickness is approximately proportional to the length of the shade in the sub-scanning direction. Here, the shade can be obtained from either the front edge or the back edge of the document, or the shade can be obtained from the average value of both, the front edge and the back edge of the document.

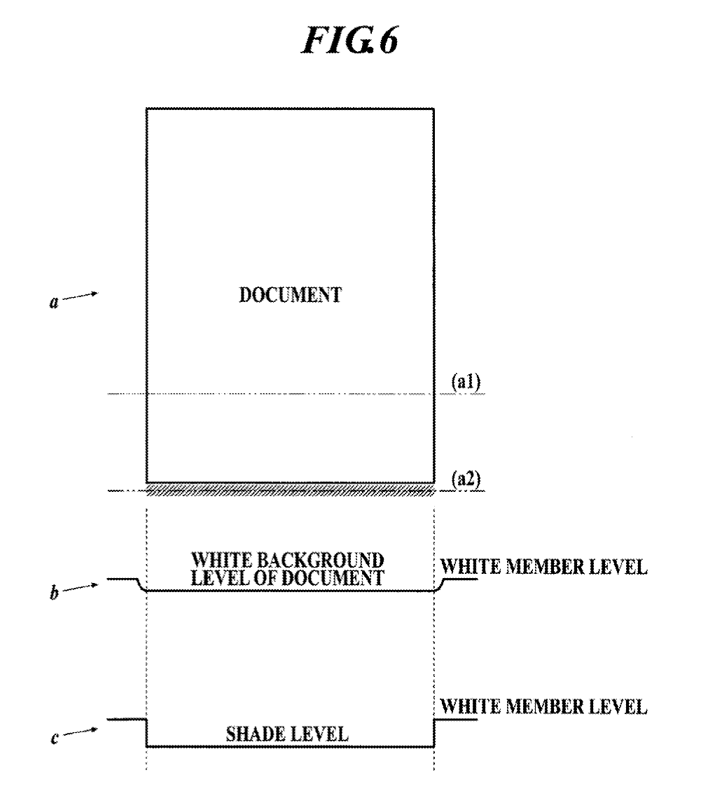

In FIG. 5, detection of whether it is the shaded part or not can be determined from the signal value distribution in the main-scanning direction. For example, when the document a as in FIG. 6 is seen in the main-scanning direction such as (a1) and (a2), the document part and the shad part can be distinguished from the difference of the signal value distribution shown by b and c. That is, they are distinguishable because the document part is slightly broader than the document and the shade part does not have this broadening. Further, they are distinguishable from the difference between the signal value (white) of the white part of the document and the signal value (black) of the shade part.

Moreover, the paper thickness can be input by a numerical value as a parameter of the paper type from an outside computer or the like via the operation unit 103 and the network before the reading is started.

When the paper type (normal paper, tracing paper, thin paper or the like) is input, the paper thickness which corresponds to the paper type can be searched by the control unit 101 from the database, the table and the like.

Preferably, when the paper thickness of the document is known before the reading of the second surface of the document is started, the reading of the second surface of the document can be dealt with the tone adjustment and the adjustment of parameter of the shading correction. Further, when the reading of the second surface of the document is dealt with the tone correction, the paper thickness needs to be known by the execution of the tone correction in order to carry out the process after storing the image data in the page memory.

When it is detected that the edge of the conveyed document have passed the document edge detection sensor 202 (YES in step S405 in FIG. 4), parameter relating to the reading of the second surface of the document is changed by the control unit 101 according to the paper thickness of the document which is detected as described above, the reading region valid signal (V-VALID, H-VALID) is supplied to the second reading unit 112 from the signal process unit 122 which received an instruction from the control unit 101, and the reading of the second surface of the document is started (step S405 to S407 in FIG. 4). Supply of the reading region valid signal (V-VALID, H-VALID) from the signal process unit 122 which received an instruction from the control unit 101 is continued and the reading of the second surface of the document is continued until it is detected that the back edge of the document have passed the document edge detection sensor 202.

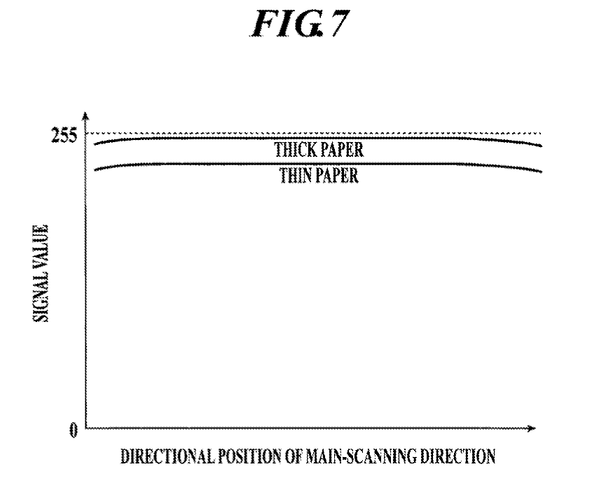

The reading result in the second reading unit 112 (CIS module 400) varies as shown in FIG. 7 according to the thickness of the document. Here, in order to simplify the description, the varying of the reading result (signal value) of the white part of the document according to the paper thickness is shown.

That is, when the reading unit which carries out the reading in a condition where the distance from the reading unit to the back surface of the reading surface of the document is constant as in the CIS module 400 is used as the second reading unit 112, the reading is to be carried out in a condition where the distance to the reading surface varies according to the thickness of the document. When the document in which the thickness is thicker than usual is to be read, the reading surface becomes closer to the reading unit and the reflection of the light which is illuminating the document become stronger than usual. That is, it becomes in a condition where the brightness is changed comparing to the original image data. In such case, when the document becomes thick, the distance to the reading surface varies according to the thickness of the document, and the signal becomes saturated and a phenomenon called the white smear can easily occur because the image data which is brighter than usual can be obtained.

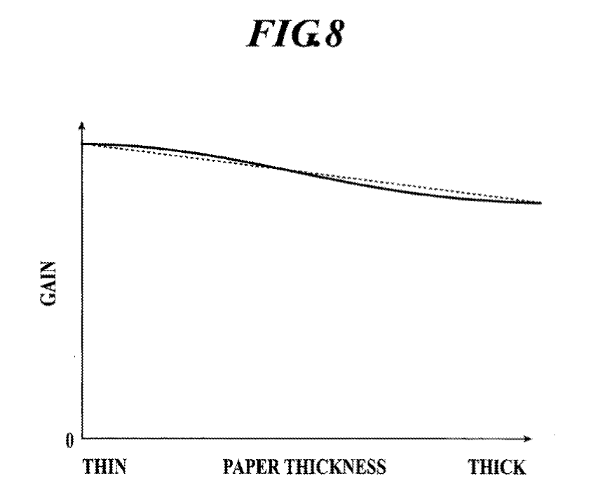

The control unit 101 controls the parameter so as to reduce the gain in the signal process unit 122 according to the increase of the paper thickness as shown in FIG. 8. In such way, the effect of the signal value of the reading result which becomes brighter by the increase of the paper thickness can be canceled out. In such case, the image data in which the effect of the thickness of the document is canceled out can be obtained after the control of changing the gain is carried out. The characteristic of FIG. 8 may be the approximation (dashed line in FIG. 8) of straight line and broken line which are calculated from several different points, or may be the true curve line (solid line in FIG. 8) obtained from number of actual measurements.

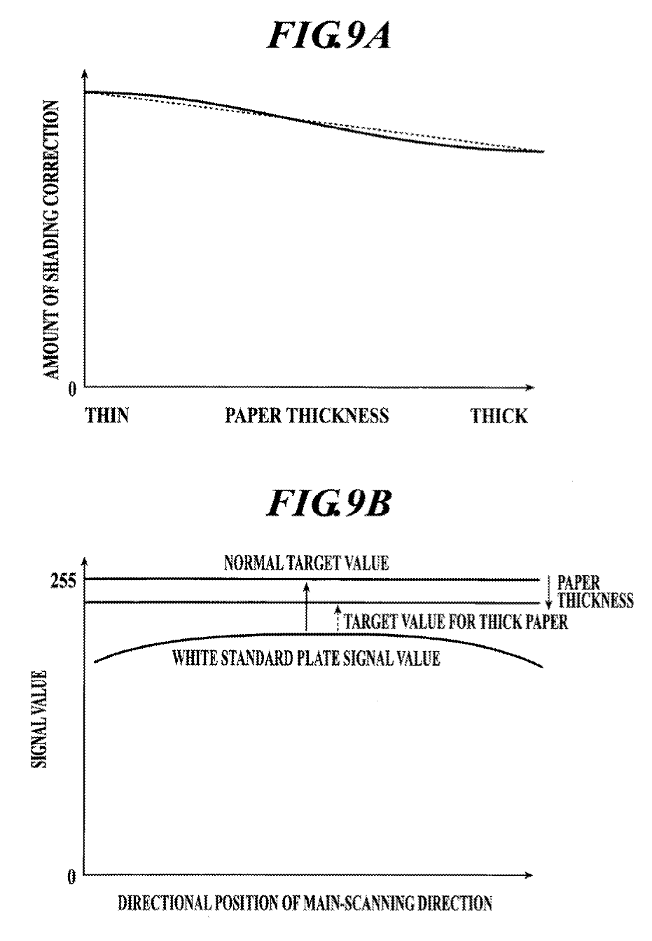

Moreover, the control unit 101 controls the parameter so as to reduce the correction amount which is applied at the time of shading correction in the signal process unit 122 according to the increase of the paper thickness as in FIG. 9A. In such case, the shading correction amount is reduced as the paper thickness increases. Thereby, the shading correction amount becomes small due to the increase of the paper thickness, and the effect of the signal value of the reading result which becomes brighter by the increasing of the paper thickness can be canceled out as shown in FIG. 9B. In such case, the image data in which the effect of the thickness of the document is canceled out can be obtained after the control of changing the gain is carried out. Here, the characteristic of FIG. 9 may be the approximation of straight line and broken line which are calculated from several different points, or may be the true curve line obtained from number of actual measurement (solid line).

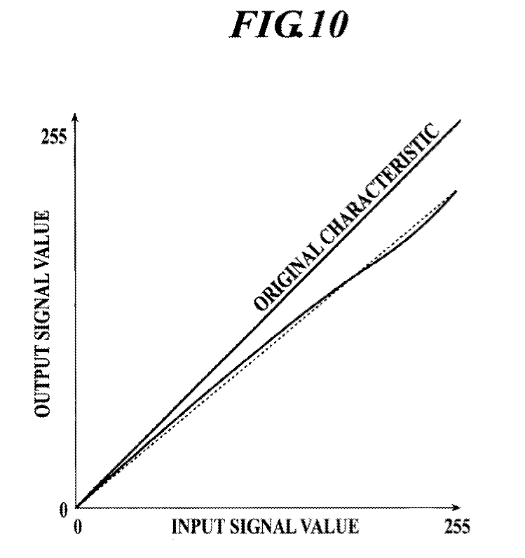

Furthermore, the control unit 101 controls the parameter of the look up table so as to lower the tone characteristic (gamma characteristic) in the image process unit 132 according to the increasing of the paper thickness as in FIG. 10. Here, case where the initial tone characteristic is a straight line is described as a specific example. Thereby, the effect of the signal value of the reading result which becomes bright due to the increase of the paper thickness can be canceled out. In such case, the process is carried out for one page worth of each pixel as a process of the tone characteristic after storing one page worth of image data in the image process unit 132. The characteristic of FIG. 10 may be the approximation (dashed line) of straight line and broken line which are calculated from number of different points, or may be the true curve line (solid) obtained from number of actual measurements.

When a predetermined timing is reached after the reading by both the first reading unit 111 and the second reading unit 112 is started, the image process unit 131 and the image process unit 132 outputs each image data to outside (step S408 in FIG. 4) by an instruction from the control unit 101, and the process is finished.

The document in which the reading is finished is ejected to the document ejection tray 22 by the document conveyance drive unit 107. When the document exists on the document tray 210, the above process is executed repeatedly.

As described above, when the reading is carried out in a condition where the distance to the surface which is opposite to the reading surface of the document is constant irradiating the document with the light by using the CIS module 400, the thickness of the document is detected by the paper thickness sensor 115 in advance and the control of changing the parameter which is used when the image data of the document which is read in the CIS module 400 is processed is carried out by the control unit 101 according to the thickness of the document. Thereby, when the document in which the thickness is thicker than usual is being read, the image data can be maintained in the usual condition (the condition in which the brightness is same as the brightness of the usual paper thickness) by changing the parameter of the process although the reflection of the light which illuminated the document becomes stronger than usual by the reading surface approximating the reading unit, and the quality of the read image can be attempted to be improved.

When the reading is carried out in a condition where the distance to the surface which is opposite of the reading surface of the document is constant by irradiating the document with the light by using the CIS module 400, the control unit 101 carries out the control of changing the parameter which is used when the image data of the document read by the CIS module 400 is processed according to the thickness of the document which is separately input from the operation unit 103 or the external device. Thereby, when the document in which the thickness is thicker than usual is being read, the image data can be maintained in the usual condition (the condition in which the brightness is same as the brightness of a usual paper thickness) by changing the parameter for processing although the reflection of the light which illuminated the document becomes stronger than usual by the reading surface approximating the reading unit, and the quality of the read image can be attempted to be improved.

When the reading is carried out in a condition where the distance to the surface which is opposite to the reading surface of the document is constant irradiating the document with the light by using the CIS module 400, the thickness of the document is detected by the first reading unit 111 in advance and the control unit 101 carries out the control of changing the parameter which is used when the image data of the document read by the second reading unit 112 is processed according to the thickness of the document. Thereby, when the document in which the thickness is thicker than usual is being read, the image data can be maintained in the usual condition (the condition in which the brightness is the same as the brightness of the usual paper thickness) by changing the parameter of the processing although the reflection of the light which illuminated the document becomes stronger than usual by the reading surface approximating the second reading unit, and the quality of the read image can be attempted to be improved.

The control unit 101 changes various types of parameters so as to cancel out the change (the change in brightness) of the signal value of the image data which occurs by the varying of the thickness of the document. Thereby, when the document in which the thickness is thicker than usual is being read, the image data can be maintained in the usual condition (the condition in which the brightness is same as the brightness of the usual paper thickness) by changing the parameter of the processing although the reflection of the light which illuminated the document becomes stronger than usual by the reading surface approximating the reading unit, and the quality of the read image can be attempted to be improved.

The control unit 101 has changed the parameter so as to cancel out the change (the change in brightness) in the signal value of the image data which occurred by varying of the thickness of the document. Further, the control unit 101 controls at least one of the tone characteristic of the image processing, the shading correction data or the gain in the signal processing of the reading unit as the parameter. Thereby, when the document in which the thickness is thicker than usual is being read, the image data can be maintained at the usual condition (the condition in which the brightness is same as the brightness of the usual paper thickness) by changing the parameter of the process although the reflection of the light which illuminated the document becomes stronger than usual by the reading surface approximating the reading unit, and the quality of the read image can be attempted to be improved.

When the reading is carried out in a condition where the distance to the surface which is opposite to the reading surface of the document is constant by irradiating the document with the light by the CIS module 400, the thickness of the document is detected by the paper thickness sensor 115 which is either of the contact type sensor or the non-contact type sensor, and the control unit 101 carries out the control of changing the parameter which is used when the image data of the document read by the reading unit is processed according to the thickness of the document. Thereby, when the document in which the thickness is thicker than usual is being read, the image data can be maintained at the usual condition (the condition in which the brightness is the same as the brightness of the usual paper thickness) by changing the parameter of the processing although the reflection of the light which illuminated the document becomes stronger than usual by the reading surface approximating the reading unit, and the quality of the read image can be attempted to be improved.

Moreover, when the reading is carried out in a condition where the distance to the surface which is opposite to the reading surface of the document is constant by irradiating the document with the light by using the CIS module 400, the control unit 101 carries out the control of changing the parameter which is used when the image data of the document read by the reading unit is processed according to the thickness of the document which is separately input from either of the operation unit 103 or the external device via the interface 106. Thereby, when the document in which the thickness is thicker than usual is to be read, the image data can be maintained in the usual condition (the condition in which the brightness is same as the brightness of the usual paper thickness) by changing the parameter of the process although the reflection of the light which illuminated the document becomes stronger than usual by the reading surface approximating the reading unit, and the quality of the read image can be attempted to be improved.

Furthermore, when the reading is carried out in a condition where the distance to the surface which is opposite to the reading surface of the document is constant by irradiating the document with the light by using the CIS module 400, the thickness of the document is detected in advance by referring to the shade area of the document which is read by the first reading unit 111, and the control unit 101 carries out the control of changing the parameter which is used when the image data of the document which is read by the second reading unit 112 is processed according to the thickness of the document. Thereby, when the document in which the thickness is thicker than usual is to be read, the image data can be maintained in the usual condition (the condition in which the brightness is same as the brightness of the usual paper thickness) by changing the parameter of the process although the reflection of the light which illuminated the document becomes stronger than usual by the reading surface approximating the second reading unit 112. Thus, the quality of the read image can be attempted to be improved.

### Other Embodiment

In the above description of the embodiment, the image reading apparatus including the first reading unit 111 and the second reading unit 112 is described as a specific example. However, the embodiment can be applied to an apparatus which reads only one surface of the document only by the CIS module 400 and to a reading apparatus which alternately reads both sides of the document by using the CIS module 400, and the preferable effect can be obtained.

Moreover, the image reading apparatus of the above embodiment can be an apparatus which reads color images and an apparatus which reads black and white images, and the preferable result can be obtained in both cases. Further, the reading device which carries out the reading in a condition where the distance to the surface which is opposite to the reading surface of the document is constant, that is, in a condition where the distance to the reading surface changes by the thickness of the document is not limited to the CIS module 400. This means that as long as it is structured so as to carry out the reading in a condition where the distance to the surface opposite to the reading surface of the document is constant, that is, in a condition where the distance to the reading surface changes by the thickness of the document even when the reading device uses the reduction optical system, the preferable effect can be obtained by applying the embodiment.

According to the first aspect of the present invention, an image reading apparatus comprises a reading unit to obtain an image data by irradiating a document with a light and reading an image of the document, a paper thickness detection unit to detect a thickness of the document to be read by the reading unit, a process unit to process the image data which is obtained by the reading unit based on a parameter and a control unit to carry out a control of changing the parameter of the process unit according to the thickness of the document which is detected by the paper thickness detection unit.

In the invention, the image data is obtained by irradiating the document with the light and by reading the image of the document, and the thickness of the document is detected by the paper thickness detection unit. Further, when the image data is processed by the process unit based on the process parameter, the parameter is controlled so as to change according to the detected thickness of the document.

In such way, when the document in which the thickness the thicker than usual is to be read, the image data can be maintained in the usual condition (the condition in which the brightness is the same as the brightness of the usual paper thickness) by changing the parameter of the process although the reflection of the light which illuminated the document becomes stronger than usual by the reading surface approximating the reading unit. Therefore, the quality of the read image can be attempted to be improved.

Moreover, when the reading is carried out in a condition where the distance to the surface opposite to the reading surface of the document is constant by irradiating the document with the light, the thickness of the document to be read in the reading unit is detected by the paper thickness detection unit in advance, and the control of changing the parameter which is used when the image data of the document which is read by the reading unit is processed is carried out according to the thickness of the document.

In such way, when the document in which the thickness is thicker than usual is to be read, the image data can be maintained in the usual condition (the condition in which the brightness is the same as the brightness of the usual paper thickness) by changing the parameter of the process although the reflection of the light which illuminated the document becomes stronger than usual by the reading surface approximating the reading unit. Therefore, the quality of the read image ran be attempted to be improved.

Preferably, the control unit changes the parameter so as to cancel out a change in a signal value of the image data which occurs by a varying of the thickness of the document.

In such way, the control unit changes the parameter so as to cancel out the change (change in brightness) of the signal value of the image data which occurs by the varying of the thickness of the document. Thereby, when the document in which the thickness is thicker than usual is to be read, the image data can be maintained in the usual condition (the condition in which the brightness is the same as the brightness of the usual paper thickness) by changing the parameter of the process although the reflection of the light which illuminated the document becomes stronger than usual by the reading surface approximating the reading unit. Therefore, the quality of the read image can be attempted to be improved.

Preferably, the control unit controls at least one of a tone characteristic of an image process, a shading correction data or a gain in a signal process of the reading unit as the parameter.

In such way, the control unit changes the parameter so as to cancel out the change (change in brightness) of the signal value of the image data which occurs by the varying of the thickness of the document, and the control unit controls at least one of the tone characteristic of the image process, the shading correction data or the gain in the signal process of the reading unit as the parameter. Thereby, when the document in which the thickness is thicker than usual is to be read, the image data can be maintained in the usual condition (the condition in which the brightness is the same as the brightness of the usual paper thickness) by changing the parameter of the process although the reflection of the light which illuminated the document becomes stronger than usual by the reading surface approximating the reading unit. Therefore, the quality of the read image can be attempted to be improved.

Preferably, the paper thickness detection unit is either one of a contact type sensor or a non-contact type sensor.

In such way, when the reading is carried out by irradiating the document with the light, the thickness of the document which is to be read in the reading unit is detected in advance by either of the paper thickness detection unit, the contact type sensor or the non-contact type sensor, and the control of changing the parameter which is used when the image data of the document read by the reading unit is processed according to the thickness of the document. Thereby, when the document in which the thickness is thicker than usual is to be read, the image data can be maintained in the usual condition (the condition in which the brightness is the same as the brightness of the usual paper thickness) by changing the parameter of the process although the reflection of the light which illuminated the document becomes stronger than usual by the reading surface approximating the reading unit. Therefore, the quality of the read image can be attempted to be improved.

Preferably, the image reading apparatus further comprises a first reading unit to read one surface of the document and a second reading unit to read the other surface of the document, and the control unit carries out the control of changing the parameter which is used when the image data obtained by at least either one of the first reading unit and the second reading unit is processed by the process unit.

In such way, when the apparatus comprises the first reading unit to read one surface of the document and the second reading unit to read the other surface of the document, the image data can be maintained in the usual condition (the condition in which the brightness is the same as the brightness of the usual paper thickness) by changing the parameter which is used when the image data obtained by at least either one of the first reading unit or the second reading unit by the process unit is processed. Therefore, the quality of the read image can be attempted to be improved.

According to the second aspect of the present invention, an image reading apparatus comprises a reading unit to obtain an image data by irradiating a document with a light and reading an image of the document, an input unit in which information relating to a thickness of the document to be read by the reading unit is input, a process unit to process the image data which is obtained by the reading unit based on a parameter and a control unit to carry out a control of changing the parameter of the process unit according to information relating to the thickness of the document which is input from the input unit.

According to the invention, when the image data is read by irradiating the document with the light and by reading the image of the document, information relating to the thickness of the document is input in the input unit, and the control of changing the parameter is carried out according to the information relating to the thickness of the document which is input from the input unit when the image data is processed by the process unit based on the process parameter.

In such way, when the document in which the thickness is thicker than usual is to be read, the image data can be maintained in the usual condition (the condition in which the brightness is the same as the brightness of the usual paper thickness) by changing the parameter of the process although the reflection of the light which illuminated the document becomes stronger than usual by the reading surface approximating the reading unit. Therefore, the quality of the read image can be attempted to be improved.

Moreover, when the reading is carried out in a condition where the distance to the surface opposite to the reading surface of the document is constant by irradiating the document with the light, the control of changing the parameter which is used when the image data of the document read by the reading unit is processed is carried out according to the thickness of the document which is input separately.

In such way, when the document in which the thickness is thicker than usual is to be read, the image data can be maintained in the usual condition (the condition in which the brightness is the same as the brightness of the usual paper thickness) by changing the parameter of the process although the reflection of the light which illuminated the document becomes stronger than usual by the reading surface approximating the reading unit. Therefore, the quality of the read image can be attempted to be improved.

Preferably, the control unit changes the parameter so as to cancel out a change in a signal value of the image data which occurs by a varying of the thickness of the document.

In such way, the control unit changes the parameter so as to cancel out the change (change in brightness) of the signal value of the image data which occurs by the varying of the thickness of the document. Thereby, when the document in which the thickness is thicker than usual is to be read, the image data can be maintained in the usual condition (the condition in which the brightness is the same as the brightness of the usual paper thickness) by changing the parameter of the process although the reflection of the light which illuminated the document becomes stronger than usual by the reading surface approximating the reading unit. Therefore, the quality of the read image can be attempted to be improved.

Preferably, the control unit controls at least one of a tone characteristic of an image process, a shading correction data or a gain in a signal process of the reading unit as the parameter.

In such way, the control unit changes the parameter so as to cancel out the change (change in brightness) of the signal value of the image data which occurs by the varying of the thickness of the document, and the control unit controls at least one of the tone characteristic of the image process, the shading correction data or the gain in the signal process of the reading unit as the parameter. Thereby, when the document in which the thickness is thicker than usual is to be read, the image data can be maintained in the usual condition (the condition in which the brightness is the same as the brightness of the usual paper thickness) by changing the parameter of the process although the reflection of the light which illuminated the document becomes stronger than usual by the reading surface approximating the reading unit. Therefore, the quality of the read image can be attempted to be improved.

Preferably, the input unit is either one of an operation unit or an external device which communicates with the image reading apparatus through a communication unit.

In such way, when the reading is carried out by irradiating the document with the light, the control of changing the parameter which is used when the image data of the document read by the reading unit is processed is carried out according to the thickness of the document which is input separately from either of the operation unit of the external device via the communication unit. Thereby, when the document in which the thickness is thicker than usual is to be read, the image data can be maintained in the usual condition (the condition in which the brightness is the same as the brightness of the usual paper thickness) by changing the parameter of the process although the reflection of the light which illuminated the document becomes stronger than usual by the reading surface approximating the reading unit. Therefore, the quality of the read image can be attempted to be improved.

Preferably, the image reading apparatus further comprises a first reading unit to read one surface of the document and a second reading unit to read the other surface of the document, and the control unit carries out the control of changing the parameter which is used when the image data obtained by at least either of the first reading unit and the second reading unit is processed by the process unit.

In such way, when the apparatus comprises the first reading unit to read one surface of the document and the second reading unit to read the other surface of the document, the image data can be maintained in the usual condition (the condition in which the brightness is the same as the brightness of the usual paper thickness) by changing the parameter which is used when the image data obtained by at least either one of the first reading unit or the second reading unit by the process unit is processed. Therefore, the quality of the read image can be attempted to be improved.

According to the third aspect of the present invention, an image reading apparatus comprises a first reading unit to read one surface of a document, a second reading unit to obtain an image data by irradiating the other surface of the document with a light and reading the other surface of the document while the one surface of the document is read by the first reading unit, a paper thickness detection unit to detect a thickness of the document to be read by the reading unit, a process unit to process the image data based on a parameter and a control unit to detect the thickness of the document from a signal obtained by the first reading unit and to carry out a control of changing the parameter which is used when the image data read by the second reading unit is processed according to the detected thickness of the document in the process unit.

In the present invention, the reading of one surface of the document is carried out by the first reading unit, and the image data is obtained by irradiating the other surface of the document with the light and reading the other surface of the document concurrently with the reading of the one surface of the document which is carried out by the first reading unit. Further, when the image data is to be processed by the process unit based on the process parameter, the thickness of the document is detected from the signal which is obtained by the first reading unit, and the control of changing the parameter which is used when the image data read by the second reading unit in the process unit is processed is carried out according to the detected thickness of the document.

In such way, when the document in which the thickness is thicker than usual is to be read, the image data can be maintained in the usual condition (the condition in which the brightness is the same as the brightness of the usual paper thickness) by changing the parameter of the process although the reflection of the light which illuminated the document becomes stronger than usual by the reading surface approximating the second reading unit. Therefore, the quality of the read image can be attempted to be improved.

Moreover, when the reading is carried out in a condition where the distance to the surface opposite to the reading surface of the document is constant by irradiating the document with the light, the thickness of the document to be read is detected in advance by the first reading unit, and the control of changing the parameter which is used when the image data of the document read by the second reading unit is processed is carried out according to the thickness of the document.

Preferably, the control unit changes the parameter so as to cancel out a change in a signal value of the image data which occurs by a varying of the thickness of the document.

In such way, the control unit changes the parameter so as to cancel out the change (change in brightness) of the signal value of the image data which occurs by the varying of the thickness of the document. Thereby, when the document in which the thickness is thicker than usual is to be read, the image data can be maintained in the usual condition (the condition in which the brightness is the same as the brightness of the usual paper thickness) by changing the parameter of the process although the reflection of the light which illuminated the document becomes stronger than usual by the reading surface approximating the reading unit. Therefore, the quality of the read image can be attempted to be improved.

Preferably, the control unit controls at least one of a tone characteristic of an image process, a shading correction data or a gain in a signal process of the reading unit as the parameter.

In such way, the control unit changes the parameter so as to cancel out the change (change in brightness) of the signal value of the image data which occurs by the varying of the thickness of the document, and the control unit controls at least one of the tone characteristic of the image process, the shading correction data or the gain in the signal process of the reading unit as the parameter. Thereby, when the document in which the thickness is thicker than usual is to be read, the image data can be maintained in the usual condition (the condition in which the brightness is the same as the brightness of the usual paper thickness) by changing the parameter of the process although the reflection of the light which illuminated the document becomes stronger than usual by the reading surface approximating the reading unit. Therefore, the quality of the read image ran be attempted to be improved.

Preferably, the control unit detects the thickness of the document by referring to a shade area of the document which is read by the second reading unit.

In such way, when the reading is carried out by irradiating the document with the light, the thickness of the document is detected in advance by referring to the shade area of the document which is read by the first reading unit, and the control of changing the parameter which is used when the image data of the document read by the second reading unit is processed is carried out according to the thickness of the document. Thereby, when the document in which the thickness is thicker than usual is to be read, the image data can be maintained in the usual condition (the condition in which the brightness is the same as the brightness of the usual paper thickness) by changing the parameter of the process although the reflection of the light which illuminated the document becomes stronger than usual by the reading surface approximating the second reading unit. Therefore, the quality of the read image can be attempted to be improved.

The present U.S. patent application claims a priority under the Paris Convention of Japanese paten application No. 2007-124781 filed on May 9, 2007, which shall be a basis of correction of an incorrect translation.

What is claimed is:

1. An image reading apparatus, comprising:
a reading unit to obtain an image data by irradiating a document with a light and reading an image of the document;
a paper thickness detection unit to detect a thickness of the document to be read by the reading unit;
a process unit to process the image data which is obtained by the reading unit based on a parameter; and
a control unit to carry out a control of changing the parameter of the process unit according to the thickness of the document which is detected by the paper thickness detection unit.

2. The image reading apparatus of claim 1, wherein
the control unit changes the parameter so as to cancel out a change in a signal value of the image data which occurs by a varying of the thickness of the document.

3. The image reading apparatus of claim 1, wherein
the control unit controls at least one of a tone characteristic of an image process, a shading correction data or a gain in a signal process of the reading unit as the parameter.

4. The image reading apparatus of claim 1, wherein
the paper thickness detection unit is either one of a contact type sensor or a non-contact type sensor.

5. The image reading apparatus of claim 1, further comprising:
a first reading unit to read one surface of the document; and
a second reading unit to read the other surface of the document, wherein
the control unit carries out the control of changing the parameter which is used when the image data obtained by at least either one of the first reading unit and the second reading unit is processed by the process unit.

6. An image reading apparatus, comprising:
a reading unit to obtain an image data by irradiating a document with a light and reading an image of the document;
an input unit in which information relating to a thickness of the document to be read by the reading unit is input;
a process unit to process the image data which is obtained by the reading unit based on a parameter; and
a control unit to carry out a control of changing the parameter of the process unit according to information relating to the thickness of the document which is input from the input unit.

7. The image reading apparatus of claim 6, wherein
the control unit changes the parameter so as to cancel out a change in a signal value of the image data which occurs by a varying of the thickness of the document.

8. The image reading apparatus of claim 6, wherein
the control unit controls at least one of a tone characteristic of an image process, a shading correction data or a gain in a signal process of the reading unit as the parameter

9. The image reading apparatus of claim 6, wherein
the input unit is either one of an operation unit or an external device which communicates with the image reading apparatus through a communication unit.

10. The image reading apparatus of claim 6, further comprising:
a first reading unit to read one surface of the document; and
a second reading unit to read the other surface of the document, wherein
the control unit carries out the control of changing the parameter which is used when the image data obtained by at least either of the first reading unit and the second reading unit is processed by the process unit.

11. An image reading apparatus, comprising:
a first reading unit to read one surface of a document;
a second reading unit to obtain an image data by irradiating the other surface of the document with a light and reading the other surface of the document while the one surface of the document is read by the first reading unit;
a paper thickness detection unit to detect a thickness of the document to be read by the reading unit;
a process unit to process the image data based on a parameter; and
a control unit to detect the thickness of the document from a signal obtained by the first reading unit and to carry out a control of changing the parameter which is used when the image data read by the second reading unit is processed according to the detected thickness of the document in the process unit.

12. The image reading apparatus of claim 11, wherein
the control unit changes the parameter so as to cancel out a change in a signal value of the image data which occurs by a varying of the thickness of the document.

13. The image reading apparatus of claim 11, wherein
the control unit controls at least one of a tone characteristic of an image process, a shading correction data or a gain in a signal process of the reading unit as the parameter.

14. The image reading apparatus of claim 11, wherein
the control unit detects the thickness of the document by referring to a shade area of the document which is read by the second reading unit.
